(19) United States
(12) Patent Application Publication
(10) Pub. No.: US 2007/0042885 A1
(43) Pub. Date: Feb. 22, 2007

(54) Packaging machine

(76) Inventors: Peter Wilhelmus Henricus Rietjens, Rh Ell (NL); Matthias Giebel, Wardenburg (DE)

Correspondence Address: PERMAN & GREEN, 425 POST ROAD, FAIRFIELD, CT, 06824, US

(21) Appl. No.: 10/563,441

(22) PCT Filed: Jul. 5, 2004
(86) PCT No.: PCT/EP04/07319

§ 371 Date: Jun. 23, 2006

(30) Foreign Application Priority Data
Jul. 4, 2003 (EP) 03015189.8

(51) Int. Cl. B31B 1/25

(52) U.S. Cl. 493/59

(57) ABSTRACT

The invention relates to a packaging machine. There are packaging machines known that form a planar material in order to produce a package. Thereby, the planar material is formed, i.e. folded, wrapped, deep-drawn or the like. The planar material is commonly provided as a plastic film, especially with a plurality of layers of different materials. To produce a package, the planar material is scored along a score line such that for example easy open features are applied to the packaging. Conventionally, large quantities of the unscored planar material is stored on rolls. According to the state of the art, in a first step, the material to score is unrolled, then scored, and finally rolled up again on a roll. This procedure can not easily be adapted to the production of different kind or forms of packages.

The invention relates to a packaging machine.

There are packaging machines known that form a planar material into a three dimensional package. The planar material is formed, i.e. folded, wrapped, deep-drawn or the like. Deep-drawn trays are often sealed with a cover film. The planar material is commonly provided as a plastic film, especially with a plurality of layers of different materials. Examples for layers are barrier-layers and/or adhesive-lavers. In a lot of cases the films are scored in order to provide for example easy opening features. Conventionally, large quantities of the unscored planar material is stored on rolls. According to the state of the art, in a first step, the material is unrolled, then scored, and finally rolled up again on a roll. This procedure can not easily be adapted to the production of different kind or forms of packages. This procedure is very time consuming and very expensive.

It is therefore the objective to provide a packaging machine for the improved production of scored packages.

The objective is achieved by providing a packaging machine according to claim 1. Preferred embodiments of the packaging machine are claimed in the independent claims.

According to the present invention, the inventive packaging machine comprises inline scoring means. Inline scoring means according to the present invention are scoring means that are part of the packaging machine and that are preferably connected to the power supply, the control system and the machine-frame of the packaging machine.

The scoring means can be any scoring means known to a person skilled in the art. Preferably the scoring means is a laser. The scoring can take place continuously or intermittendly. The film can be scored while it moves or while it is stationary. However a scoring during the movement of the film is preferred.

Preferably, the scoring means are incorporated such into the packaging machine, that the scoring pattern are changed easily. More preferably, the scoring pattern is changeable by a computer, for example by a software modification or by utilizing stored pattern of scores.

In a preferred embodiment of the present invention, the laser and/or means that guide the laser beam to the film are attached alterably at the packaging machine. Preferably, the alteration is carried out automatically, for example by servo motors or equivalent means. Servo motors have the advantage that exact position of the laser or the guiding means. The servo motor can be used to used to alter the scoring pattern and/or to move the equipment to produce a certain pattern.

The scoring can be positioned at every location within the packaging machine. It can be used to score the base film from which trays are produced, the film used for the lid and/or the film utilized on horizontal or vertical flow-wrappers.

In case that more than one scoring lines per package, the inventive machine comprises preferably switching means to produce a first and a second score into the planar material. These means, for example a mirror and/or a lens, switch preferably the impact point of the laser beam relative to the planar material between the first and the second line. Thus, preferably, the means are, preferably automatically, movable. In another embodiment of the present invention, the means can change their pysical properties such that they direct the laser beam to different locations.

In a preferred embodiment of the present invention, the switching means are provided such that the laser beam is directed differently depending on an electrical field, applied especially to a Kerr-cell.

The present invention is now explained in further detail according to FIGS. 1-6. These explanation do not limit the scope of protection.

FIG. 1 shows schematically the inventive packaging machine

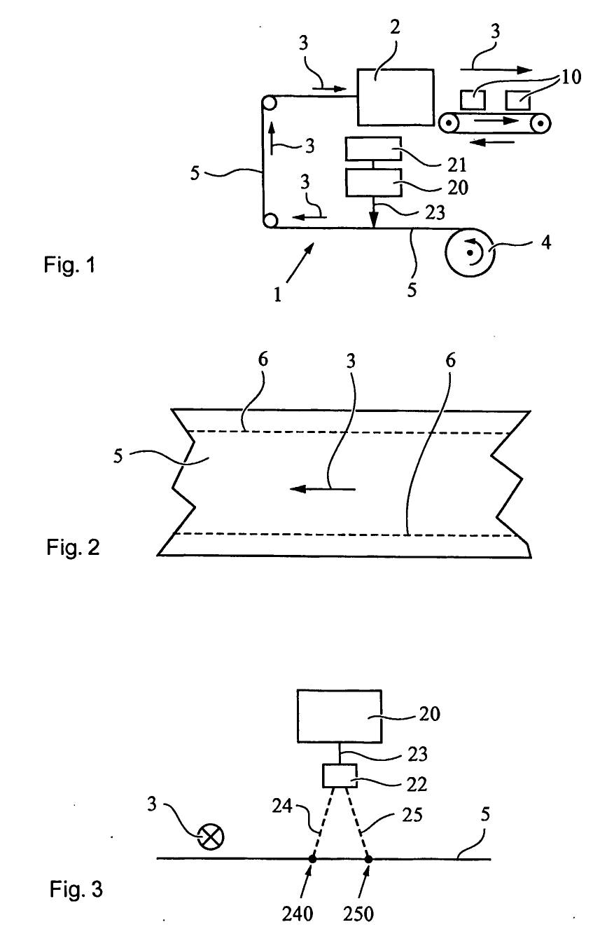

FIG. 2 shows the scored planar material

FIG. 3 shows another embodiment of the scoring means

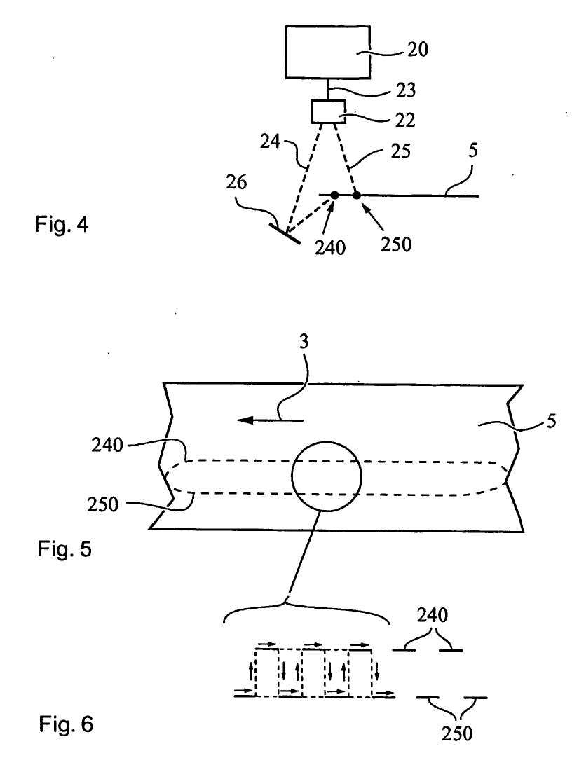

FIG. 4 shows still a further embodiment of the scoring means

FIGS. 5, 6 show the effect of the switching of the laser beam

FIG. 1 shows schematically a packaging machine 1 according to the present invention with means 2 to form, i.e. to at least partially deform, a planar material 5 elastically and/or plastically, which is delivered on a roll 4. The direction of the movement of the planar material 5 is indicated by arrows 3. The planar material 5 is formed in the means 2 especially by folding, bending, deep-drawing or the like. After forming the planar material 5, the means 2 comprises the possibility to fill and close the packages 10, especially by sealing. The packaging machine 1 according to the present invention is provided such that, prior to forming the planar material 5, the planar material 5 is scored by a scoring means 20. The scoring means 20 are controlled by a controller 21, which is preferably part of the overall control system of the packaging machine and the scoring means 20 scores the planar material 5 through an energy output 23 of the scoring means 20 towards the planar material 5. According to the invention, the scoring means 20 are especially provided as a laser 20 and the energy output 23 of the scoring means 20 is especially provided as a laser beam 23. One advantage of the configuration of the packaging machine 1 according to the present invention is that there is no need to dissociate the scoring from the production of the packaging, one control system, one energy supply and one machine frame can be utilized. Therefore, no logistical problems occur or there is no need to feed the packaging machine 1 only with complete rolls of scored planar material 5. The scoring pattern can be changed within a very short period of time. The production of packages is therefore very easy and much more flexible with a packaging machine 1 according to the present invention.

In FIG. 2 the scored planar material 5 is shown schematically viewed from above with two scores 6. In the embodiment shown, the scores 6 are provided as straight lines, but a skilled person understands that the scores 6 can also be provided as curved lines by controlling the laser 20 appropriately. It is to be understood, that the planar material 5 is moving continuously or semi-continuously in the direction of the arrow 3. Therefore, the laser 20 has to be controlled such that—while the planar material 5 moves—the laser beam 23 moves relative to the planar material 5 along the line at which the score 6 needs to be applied. Such a control of the laser beam 23 can be provided by the controller 21 e.g. through a software-implemented control mechanism. Therefore the movement of the laser beam 23 and accordingly the form of the score 6 can easily be adapted to different packages to produce. The form of the score 6 is also called the scoring pattern. By providing a software-implemented control of the controller 21, it is possible to change the scoring pattern only by modifying the software or by applying a different scoring pattern of a plurality of alternative scoring patterns already provided in the software. A flexible production of different packages is therefore possible. In the example of the embodiment shown in FIG. 2, the score 6 and the direction of movement 3 of the material 5 is approximately parallel, which implies that the laser 20 and/or the laser beam 23 does not necessarily need to move. When the transportation of the films stops or slows down accidentally or due to the production, the energy output of the laser has to be turned down or shut off.

According to the invention, the packaging machine can be provided as a horizontal flowwrapper or as a vertical flowwrapper, a tray sealer or a thermoformer or a combination there of.

In FIG. 3, another embodiment of the scoring means 20 is depicted schematically in greater detail in a side view together with the planar material 5. The scoring means 20, i.e. the laser 20, comprises switching means 22 which are provided such that the laser beam 23 can be switched between a first direction and a second direction. The laser beam 23 directed to the first direction is indicated by reference sign 24 and the laser beam 23 directed to the second direction is indicated by reference sign 25. The laser beam 24 hits the planar material 5 at a first impact point and the laser beam 25 hits the planar material 5 at a second impact point. While the movement of the laser beams 24, 25 together with the movement 3 of the planar material 5 provides a continuous change of the first and second impact points, the first impact points form together a first score line 240 and the second impact points form together a second score line 250. The score lines 240, 250 are especially formed of a multitude of small scores more or less aligned one after the other. In the example of the embodiment shown in FIG. 3, the movement 3 of the material 5 is directed perpendicular to the paper plane which is indicated by the “arrow” 3, pointing in the paper plane. The switching means 22 comprises preferably a mechanically movable object, especially a mirror, directing the laser beam 23, 24, 25 differently depending on the position of the movable object. For example, the movable object—realised as a mirror or another reflecting surface—can be inclined differently in order to direct the laser beam 23, 24, 25 in a different direction. In other words, the movable object can be provided such that it describes a rotational movement. Alternatively, the movable object can also be provided such that it describes a translational movement, thereby switching for example between a position where the laser beam 23 hits the movable object at a transmitting region and a position where the laser beam 23 hits the movable object at a reflecting region In another embodiment of the laser 20, the switching means 22 are provided such that the laser beam 23, 24, 25 is directed differently depending on an electrical field, applied especially to a Kerr-cell or applied to an object whose reflectivity changes subject to the application of an electrical field.

In FIG. 4, still a further embodiment of the scoring means 20 is depicted schematically in a side view together with the planar material 5. The scoring means 20 comprise, other the switching means 22, a reflecting means 26. The reflecting means 26 reflects—in the example shown—the laser beam 24 towards the opposite side of the planar material 5 compared to the laser beam 25. Therefore, the first score line 240 and the second score line 250 can be advantageously provided on different sides of the planar material 5.

A comparison between FIGS. 3 and 4 show that the laser can be applied from the top and from the bottom.

In FIG. 5 and FIG. 6, the effect of the switching of the laser beam 23 by the switching means 22 is schematically shown. In FIG. 5 the first and second score line 240, 250 are depicted in dotted lines on the planar material 5. In FIG. 6 an enlarged cut-out of the first and second score lines 240, 250 is depicted. In FIG. 6, the multitude of scores of the score lines 240, 250 are illustrated with drawn-though lines respectively. The movement of the laser beam 24, 25 relative to the material 5 along the score lines 240, 250 is illustrated by small arrows.

With the switching means 22 according to the present invention, it is possible to provide a multitude of scores 6 with only one laser 20, therefore rendering the packaging machine 1 more cost effective and light weight.

1. Packaging machine (1) with means (2) to form a planar material (5) in order to produce a packaging (10), characterized in that the packaging machine (1) comprises inline scoring means (20) to provide a score (6, 24, 25) in the planar material (5) prior to forming.

2. Packaging machine (1) according to claim 1, characterized in that the scoring means (20) is a laser.

3. Packaging machine (1) according to any of the preceding claims, characterized in that the scoring pattern is changeable by a software modification.

4. Packaging machine (1) according to any of the preceding claims, characterized in that during inline scoring the planar material (5) is moved horizontally or vertically.

5. Packaging machine (1) according to any of the preceding claims, characterized in that the packaging machine (1) comprises switching means (22) to produce a score in the planar material along a first line (240) and along a second line (250) by switching the impact point of the laser beam (23, 24, 25) to the planar material (5) between the first and the second line (240, 250).

6. Packaging machine (1) according to any of the preceding claims, characterized in that the switching means (22) comprise a mechanically movable object, especially a mirror, directing the laser beam differently depending on the position of the object.

7. Packaging machine (1) according to any of the preceding claims, characterized in that the switching means (22) are provided such that the laser beam (23, 24, 25) is directed differently depending on an electrical field, applied especially to a Kerr-cell.

8. Packaging machine (1) according to any of the preceding claims, characterized in that the packaging machine (1) is a horizontal or a vertical flowwraper.

9. Method to produce a scored package from a film, whereas the film is shaped to form the package and the film is scorred, characterized in that, the film is scored while it is transported on in the packaging machine.

10. Method according to claim 9, characterized in, that it is scoring takes place prior, during or after the forming of the film.

11. Method according to one of the preceding claims, characterized in, that one or two films are sealed.

12. Method according to claim 11, characterized in, that the scoring takes place prior during or after the sealing.
